(19) United States
(12) Patent Application Publication
(10) Pub. No.: US 2025/0123140 A1
(43) Pub. Date: Apr. 17, 2025

(54) SIGNAL PROCESSING APPARATUS, METHOD, AND NON-TRANSITORY COMPUTER-READABLE MEDIUM

(71) Applicant: NEC Corporation, Minato-ku, Tokyo (JP)

(72) Inventors: Wataru Kohno, Tokyo (JP); Sakiko Mishima, Tokyo (JP); Reishi Kondo, Tokyo (JP); Tomoyuki Hino, Tokyo (JP)

(73) Assignee: NEC Corporation, Minato-ku, Tokyo (JP)

(21) Appl. No.: 18/834,759

(22) PCT Filed: Feb. 21, 2022
(86) PCT No.: PCT/JP2022/007019

§ 371 Date: Jul. 31, 2024

(51) Int. Cl. G01H 9/00; G01D 5/353

(52) U.S. Cl. CPC G01H 9/004; G01D 5/35358

(57) ABSTRACT

It is an object of the present disclosure to provide a signal processing apparatus, a system, a method, and a non-transitory computer-readable medium capable of estimating the signal generation position in consideration of the optical fiber laying information and the optical fiber gauge length. A signal processing apparatus according to the present disclosure includes: a signal source candidate generation means configured to generate a plurality of signal source candidate positions; a composite data generation means configured to calculate a distortion signal, which is generated when a signal generated from a signal source distorts an optical fiber, based on a plurality of pieces of optical fiber laying information, a plurality of optical fiber gauge lengths, and the plurality of signal source candidate positions.

### TECHNICAL FIELD

The present disclosure relates to a signal processing apparatus, a system, a method, and a non-transitory computer-readable medium, and particularly relates to a signal processing apparatus, a system, a method, and a non-transitory computer-readable medium capable of estimating a signal generation position in consideration of optical fiber laying information and an optical fiber gauge length.

### BACKGROUND ART

A Phase-Sensitive OTDR (Phase-Sensitive Optical Time Domain Reflectometer) capable of detecting vibration/sound generated in any section on an optical fiber by optical fiber sensing is known. The OTDR is an apparatus that receives a coherent light pulse signal and detects a difference between two points on an optical fiber having a phase of backscattered light (Rayleigh scattered light) to detect dynamic distortion of the optical fiber in a phase difference evaluation section (gauge length section). In addition, this may also be referred to as a distributed acoustic sensing (DAS) apparatus.

Non Patent Literature 1 discloses estimating a position or a direction of a signal source away from an optical fiber from a relationship between an acoustic signal detected on the optical fiber and actual spatial distribution information of the optical fiber. Specifically, a two-dimensional/three-dimensional sound source position estimation method using an optical fiber sensor using a coiled sensor head is disclosed.

Non Patent Literature 2 discloses imaging waveform amplitudes and comparing performance of behavioral event detection with several convolutional neural network (CNN) models.

Non Patent Literature 3 discloses that a learning model is constructed from composite data by straight lines using the linearity of the trajectories of traffic vehicles appearing in waveform amplitude data.

Patent Literature 1 discloses that there is a structure that has a non-linear shape and generates non-uniform strain when displacement occurs and that Brillouin scattered light generated in an optical fiber fixed to the structure is detected and observation power spectrum data is measured from the Brillouin scattered light. In addition, Patent Literature 1 discloses that a model power spectrum shape of Brillouin scattered light generated corresponding to the magnitude of displacement of a structure is theoretically calculated, the model power spectrum shape is applied to observation power spectrum data, and the displacement of the structure is calculated based on the model power spectrum shape of the fitted best fit curve shape. Patent Literature 1 does not disclose estimating a signal generation position in consideration of optical fiber laying information and an optical fiber gauge length.

Patent Literature 2 discloses an optical coherent sensor including a light source unit that generates a light pulse as probe light, a light receiving unit that generates a beat signal by coherently detecting signal light generated by a measurement target due to the probe light, and a calculation unit to which the beat signal is input. In addition, Patent Literature 2 discloses that a calculation unit includes an optical information acquisition means, an accuracy degradation avoidance means, and a phase difference information acquisition means, the optical information acquisition means acquires, from the beat signal, the distribution of the intensity and phase of signal light with respect to the light reception time of signal light for each optical pulse, the accuracy degradation avoidance means sets a reference time, and the phase difference information acquisition means acquires a phase difference with respect to the light reception time of signal light as a phase difference between the light reception time and the light reception time in which tk>tj>ti and a difference between t and ti is a reference time, and acquires a distribution of the phase difference with respect to the light reception time of signal light. Patent Literature 2 does not disclose estimating a signal generation position in consideration of optical fiber laying information and an optical fiber gauge length.

### CITATION LIST

### Patent Literature

Patent Literature 1: Japanese Unexamined Patent Application Publication No. 2012-047699
Patent Literature 2: Japanese Unexamined Patent Application Publication No. 2020-159915

### Non Patent Literature

Non Patent Literature 1: J. Liang, et al., “Distributed acoustic sensing for 2D and 3D acoustic source localization”, Opt. Lett. 44, 1690-1693 (2019)
Non Patent Literature 2: Y. Shi, et al., “An Event Recognition Method for Ø-OTDR Sensing System Based on Deep Learning”, Sensors, 19, 3421 (2019)
Non Patent Literature 3: C. Narisetty, et al., “Overcoming challenges of distributed fiber-optic sensing for highway traffic monitoring”, J. of the Transportation Research Board, 2, 2675 (2021)

### SUMMARY OF INVENTION

### Technical Problem

As described above, the OTDR detects the dynamic distortion (distortion signal) of the optical fiber in the gauge length section by detecting the difference (phase difference) between two points on the optical fiber. The phase difference acquired by the OTDR greatly changes depending on the laying status of the optical fiber or the set value of the gauge length of the optical fiber. In the signal position estimation method, an occurrence position of a signal causing a distortion signal is estimated based on the distortion signal detected by the OTDR. Therefore, in order to perform more accurate position estimation, it is necessary to detect the distortion signal in consideration of the laying status of the optical fiber or the gauge length of the optical fiber and to estimate the signal generation position based on the detected distortion signal.

It is an object of the present disclosure to provide a signal processing apparatus, a system, a method, and a non-transitory computer-readable medium that solve the above-described problems.

### Solution to Problem

A signal processing apparatus according to the present disclosure includes:
a signal source candidate generation means for generating a plurality of signal source candidate positions;
a composite data generation means for calculating a distortion signal, which is generated when a signal generated from a signal source distorts an optical fiber, based on a plurality of pieces of optical fiber laying information, a plurality of optical fiber gauge lengths, and the plurality of signal source candidate positions;
a measured data processing means for receiving a phase difference signal of backscattered light in an optical fiber gauge length section when an optical pulse signal is input to the optical fiber and converting the phase difference signal into a distortion signal; and
a signal source candidate condition selection means for selecting a predetermined distortion signal having a highest similarity to the converted distortion signal from the plurality of calculated distortion signals, selecting a predetermined signal source candidate position corresponding to the predetermined distortion signal from the plurality of signal source candidate positions, and estimating the predetermined signal source candidate position as a generation position of the signal.

A system according to the present disclosure includes:
a distributed acoustic sensing (DAS) apparatus; and
a signal processing apparatus.

The distributed acoustic sensing apparatus includes:
a phase difference detection means for detecting a phase difference signal of backscattered light in an optical fiber gauge length section when an optical pulse signal is input to an optical fiber.

The signal processing apparatus includes:
a signal source candidate generation means for generating a plurality of signal source candidate positions;
a composite data generation means for calculating a distortion signal, which is generated when a signal generated from a signal source distorts an optical fiber, based on a plurality of pieces of optical fiber laying information, a plurality of optical fiber gauge lengths, and the plurality of signal source candidate positions;
a measured data processing means for receiving the phase difference signal and converting the phase difference signal into the distortion signal; and
a signal source candidate condition selection means for selecting a predetermined distortion signal having a highest similarity to the converted distortion signal from the plurality of calculated distortion signals, selecting a predetermined signal source candidate position corresponding to the predetermined distortion signal from the plurality of signal source candidate positions, and estimating the predetermined signal source candidate position as a generation position of the signal.

A method according to the present disclosure includes:
generating a plurality of signal source candidate positions;
calculating a distortion signal, which is generated when a signal generated from a signal source distorts an optical fiber, based on a plurality of pieces of optical fiber laying information, a plurality of optical fiber gauge lengths, and the plurality of signal source candidate positions;
receiving a phase difference signal of backscattered light in an optical fiber gauge length section when an optical pulse signal is input to the optical fiber and converting the phase difference signal into a distortion signal; and
selecting a predetermined distortion signal having a highest similarity to the converted distortion signal from the plurality of calculated distortion signals, selecting a predetermined signal source candidate position corresponding to the predetermined distortion signal from the plurality of signal source candidate positions, and estimating the predetermined signal source candidate position as a generation position of the signal.

A non-transitory computer-readable medium according to the present disclosure stores a program causing a computer to execute:
generating a plurality of signal source candidate positions;
calculating a distortion signal, which is generated when a signal generated from a signal source distorts an optical fiber, based on a plurality of pieces of optical fiber laying information, a plurality of optical fiber gauge lengths, and the plurality of signal source candidate positions;
receiving a phase difference signal of backscattered light in an optical fiber gauge length section when an optical pulse signal is input to the optical fiber and converting the phase difference signal into a distortion signal; and
selecting a predetermined distortion signal having a highest similarity to the converted distortion signal from the plurality of calculated distortion signals, selecting a predetermined signal source candidate position corresponding to the predetermined distortion signal from the plurality of signal source candidate positions, and estimating the predetermined signal source candidate position as a generation position of the signal.

### Advantageous Effects of Invention

According to the present disclosure, it is possible to provide a signal processing apparatus, a system, a method, and a non-transitory computer-readable medium capable of estimating the signal generation position in consideration of the optical fiber laying information and the optical fiber gauge length.

### BRIEF DESCRIPTION OF DRAWINGS

FIG. 1 is a block diagram illustrating a system according to a first example embodiment.

FIG. 2 is a block diagram illustrating a signal processing apparatus according to the first example embodiment.

FIG. 3 is a schematic diagram illustrating an operation of a distributed acoustic sensing (DAS) apparatus.

FIG. 4 is a schematic diagram illustrating the influence of a gauge length.

FIG. 5 is a flowchart illustrating an operation of a signal source candidate generation means according to the first example embodiment.

FIG. 6 is a flowchart illustrating an operation of a composite data generation means according to the first example embodiment.

FIG. 7A is a flowchart illustrating an operation of a composite data storage means according to the first example embodiment.

FIG. 7B is a schematic diagram illustrating a storage table of the composite data storage means according to the first example embodiment.

FIG. 8 is a flowchart illustrating an operation of a measured data processing means according to the first example embodiment.

FIG. 9 is a flowchart illustrating an operation of a signal source candidate condition selection means according to the first example embodiment.

FIG. 10 is a schematic diagram illustrating a specific example of a system according to the first example embodiment.

FIG. 11 is a block diagram illustrating processing contents in each element of the signal processing apparatus according to the first example embodiment.

FIG. 12A is a schematic diagram illustrating similarity in the signal source candidate condition selection means according to the first example embodiment.

FIG. 12B is a schematic diagram illustrating similarity in the signal source candidate condition selection means according to the first example embodiment.

FIG. 12C is a schematic diagram illustrating similarity in the signal source candidate condition selection means according to the first example embodiment.

FIG. 12D is a schematic diagram illustrating similarity in the signal source candidate condition selection means according to the first example embodiment.

FIG. 13 is a block diagram illustrating a signal processing apparatus according to a second example embodiment.

FIG. 14 is a schematic diagram illustrating a divided space according to the second example embodiment.

FIG. 15 is a flowchart illustrating an operation of the signal processing apparatus according to the second example embodiment.

FIG. 16 is a schematic diagram illustrating a divided space according to the second example embodiment.

### EXAMPLE EMBODIMENT

Hereinafter, example embodiments of the present invention will be described with reference to the diagrams. In the diagrams, the same or corresponding elements are denoted by the same reference numerals, and repeated description will be omitted as necessary for clarity of description.

### First Example Embodiment

### <Configuration>

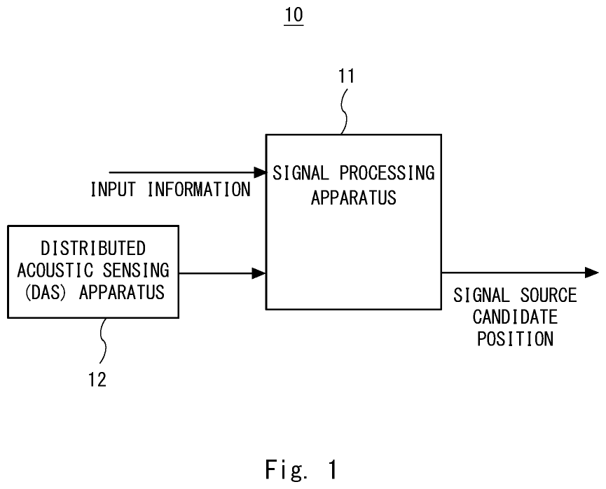

FIG. 1 is a block diagram illustrating a system according to a first example embodiment.

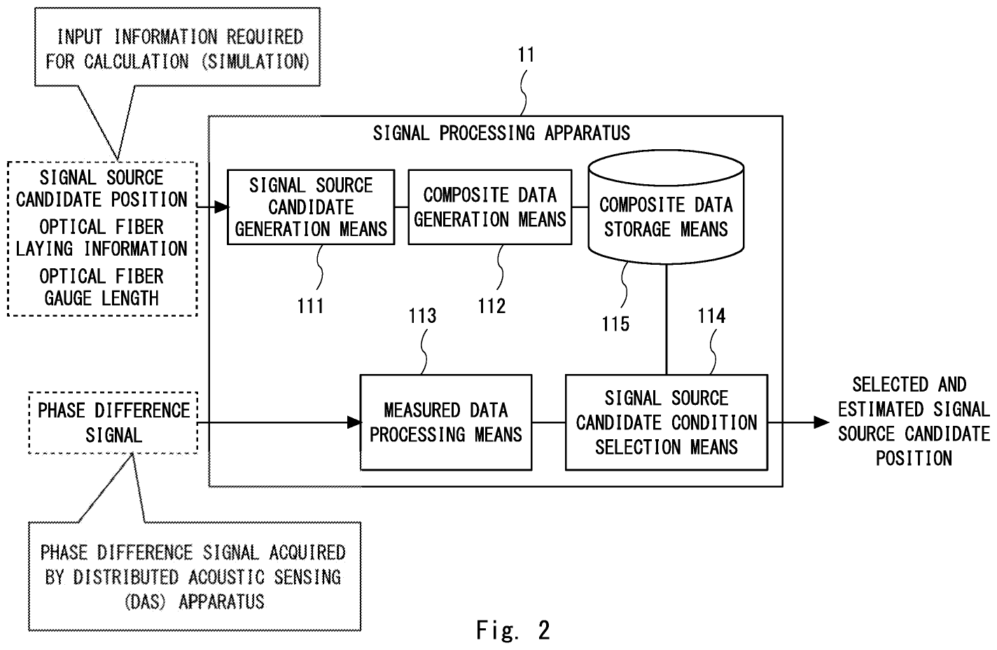

FIG. 2 is a block diagram illustrating a signal processing apparatus according to the first example embodiment.

As illustrated in FIG. 1, a system 10 according to the first example embodiment includes a distributed acoustic sensing (DAS) apparatus 12 and a signal processing apparatus 11.

As illustrated in FIG. 2, the signal processing apparatus 11 includes a signal source candidate generation means 111, a composite data generation means 112, a measured data processing means 113, and a signal source candidate condition selection means 114.

The signal source candidate generation means 111 generates a plurality of signal source candidate positions. The signal source candidate position indicates a position that is a candidate for the signal source. The signal may be, for example, a mechanical vibration, a physical vibration, and/or a sound signal (acoustic signal). The signal source is, for example, a sound source, and indicates a position where the sound is emitted. In addition, the signal source may indicate, for example, a position where vibration has occurred.

When generating signal source candidate positions, the signal source candidate generation means 111 does not randomly generate the signal source candidate positions. Although an optical fiber sensor for detecting sound or vibration emitted from the signal source is laid, the signal source candidate generation means 111 may generate the signal source candidate positions based on the optical fiber laying information indicating the laying status. For example, when the optical fiber is linearly laid, signal source candidate positions are generated at equal intervals along the optical fiber. In addition, for example, when the optical fiber is laid so as to surround a predetermined space or a periphery of a predetermined region, the predetermined space is divided into a mesh shape, and signal source candidate positions are generated in the respective divided regions.

That is, the signal source candidate generation means 111 generates, as a plurality of signal source candidate positions, positions in a plurality of first divided spaces obtained by dividing a predetermined space including an optical fiber into a mesh shape or a plurality of positions along the optical fiber.

The composite data generation means 112 calculates a distortion signal generated by the signal generated from the signal source distorting the optical fiber, based on a plurality of pieces of optical fiber laying information, a plurality of optical fiber gauge lengths, and a plurality of signal source candidate positions. In addition, the optical fiber gauge length may be simply referred to as a gauge length. A sensor using an optical fiber as a sensor medium is referred to as an optical fiber sensor.

In the first example embodiment, the distortion signal generated by the signal generated from the signal source distorting the optical fiber is calculated, but the present invention is not limited thereto. As a result of the signal generated from the signal source affecting the optical fiber, the generated signal may be calculated as composite data. Therefore, the distortion signal may be referred to as composite data.

The composite data generation means 112 calculates the value of the optical fiber distortion signal of the number of (the number of a plurality of pieces of optical fiber laying information)×(the number of a plurality of gauge lengths)×(the number of a plurality of signal source candidate positions). Therefore, for example, the composite data generation means 112 sets the optical fiber laying information and the gauge length of the optical fiber to fixed values, and calculates the distortion signal of the optical fiber when the signal source candidate position is changed. In addition, for example, the composite data generation means 112 sets the optical fiber laying information and the signal source candidate positions to fixed values, and calculates the distortion signal of the optical fiber when the gauge length of the optical fiber is changed. In addition, for example, the composite data generation means 112 sets the gauge length and the signal source candidate position of the optical fiber to fixed values, and calculates the distortion signal of the optical fiber when the optical fiber laying information is changed.

That is, the composite data generation means 112 calculates the distortion signals of a plurality of optical fibers when at least one of the optical fiber laying information, the gauge length of the optical fiber, and the signal source candidate position is changed.

The phase difference signal acquired by the distributed acoustic sensing apparatus 12 is input to the measured data processing means 113. The measured data processing means 113 converts the input phase difference signal into a distortion signal. Details of a method of converting the phase difference signal into the distortion signal will be described later.

The signal source candidate condition selection means 114 selects a predetermined distortion signal having the highest similarity to the converted distortion signal from the plurality of calculated distortion signals. Details of a method of selecting a predetermined distortion signal having the highest similarity will be described later. The signal source candidate condition selection means 114 selects a predetermined signal source candidate position corresponding to the selected predetermined distortion signal from a plurality of signal source candidate positions. The signal source candidate condition selection means 114 estimates the selected predetermined signal source candidate position as a signal generation position, that is, a signal source.

In addition, when the signal source candidate generation means 111 generates, as a plurality of signal source candidate positions, positions in a plurality of first divided spaces obtained by dividing a predetermined space including an optical fiber into a mesh shape, the signal source candidate condition selection means 114 may select a predetermined signal source candidate position from the plurality of first divided spaces and estimate the predetermined signal source candidate position as the signal generation position.

In addition, the signal processing apparatus 11 may further include a composite data storage means 115 for storing the plurality of distortion signals calculated by the composite data generation means 112. At this time, the composite data storage means 115 stores the optical fiber laying information, the optical fiber gauge length, the signal source candidate positions, and the distortion signal obtained as a result of the calculation in association with each other.

The distributed acoustic sensing apparatus 12 includes a phase difference detection means (not illustrated) that detects a phase difference signal of backscattered light in an optical fiber gauge length section when an optical pulse signal is input to an optical fiber. The distributed acoustic sensing apparatus 12 is an apparatus that detects a phase difference signal of backscattered light in an optical fiber gauge length section using distributed acoustic sensing using an optical fiber as a sensor medium. The distributed acoustic sensing apparatus 12 may use an existing communication optical fiber as a sensor.

The signal source candidate condition selection means 114 may narrow down a selection range for selecting a predetermined distortion signal from the plurality of calculated distortion signals based on the optical fiber laying information and the optical fiber gauge length of the optical fiber to which the optical pulse signal is input.

### <Effects>

When the signal generation position is estimated, the position greatly changes depending on the laying status of the optical fiber and the set value of the gauge length of the optical fiber. The signal processing apparatus 11 (or the system 10) according to the first example embodiment selects a predetermined distortion signal having the highest similarity to the measured distortion signal from a plurality of pieces of composite data (distortion signals) calculated based on the optical fiber laying information, the optical fiber gauge length, and the signal source candidate positions, and estimates a signal source candidate position corresponding to the predetermined distortion signal as a signal generation position. Since the signal processing apparatus 11 (or the system 10) according to the first example embodiment estimates the signal generation position in consideration of the optical fiber laying information and the optical fiber gauge length, more accurate position estimation can be performed.

That is, according to the first example embodiment, it is possible to provide a signal processing apparatus, a system, a method, and a non-transitory computer-readable medium capable of estimating the signal generation position in consideration of the optical fiber laying information and the optical fiber gauge length. Therefore, it is possible to more accurately estimate position of the signal generation position.

In addition, in the system 10 according to the first example embodiment, an existing optical fiber for communication can be made into a sensor and used as a distributed acoustic sensing apparatus, it is possible to reduce the cost of the system.

In addition, in the system 10 according to the first example embodiment, the entire optical fiber becomes a sensor medium by supplying power only to the optical fiber sensor box, and a phase difference signal can be received from the DAS apparatus. Therefore, according to the first example embodiment, it is possible to reduce the number of parts to which power is supplied (power saving property) as compared with a case of estimating the signal generation position using a vibration sensor or a microphone that operates electronically.

In addition, the system 10 according to the first example embodiment uses an optical fiber sensor obtained by making an optical fiber into a sensor. The optical fiber sensor is electromagnetic and/or corrosion-resistant because the sensor medium is made of glass.

### <Operation of DAS Apparatus>

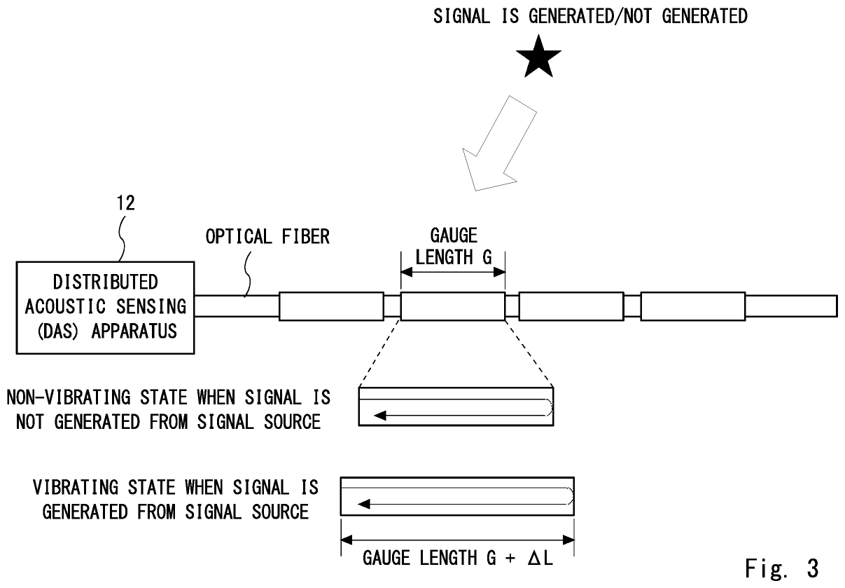

FIG. 3 is a schematic diagram illustrating an operation of a distributed acoustic sensing (DAS) apparatus.

As illustrated in FIG. 3, when no signal is generated from the signal source, the optical fiber is not affected at all and is in a non-vibrating state and accordingly, does not expand and contract. On the other hand, when a signal is generated from the signal source, the optical fiber is distorted by the signal, and the optical fiber is in a vibrating state and accordingly, expands and contracts. The distributed acoustic sensing (DAS) apparatus measures distortion ΔL of an optical fiber through a phase difference signal of backscattered light in a gauge length section. The optical fiber has a plurality of gauges, and operates as an independent vibration/acoustic optical fiber sensor in each gauge length section. In the first example embodiment, the distributed acoustic sensing apparatus transmits a phase difference signal obtained when a signal is generated from the signal source to the signal processing apparatus 11.

### <Influence of Gauge Length>

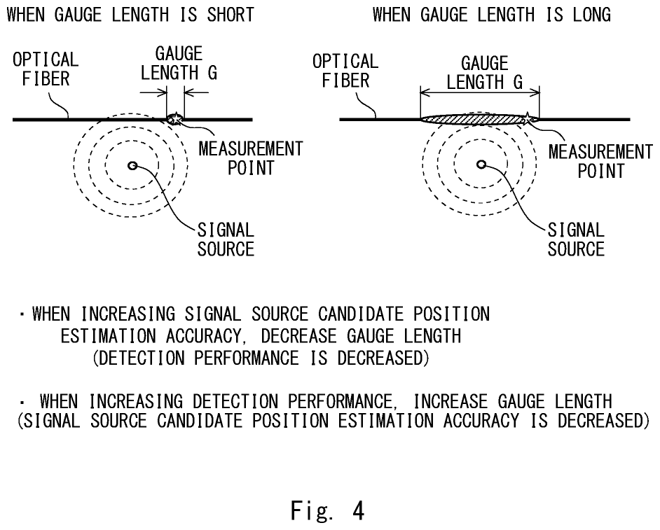

FIG. 4 is a schematic diagram illustrating the influence of a gauge length.

The left diagram of FIG. 4 is a schematic diagram illustrating the state of vibration generated from a signal source when the gauge length is short.

The right diagram of FIG. 4 is a schematic diagram illustrating the state of vibration generated from a signal source when the gauge length is long.

The DAS apparatus receives a coherent light pulse signal and detects a difference between two points on an optical fiber having a phase of backscattered light to detect dynamic distortion (distortion signal) of the optical fiber in a phase difference evaluation section (gauge length section). The gauge length is a distance (length) between two points on the optical fiber.

Here, as the gauge length increases, the SN ratio (signal-to-noise ratio) increases because the phase difference between the non-vibrating state and the vibrating state increases, and the signal source candidate position estimation accuracy (spatial resolution) decreases because the distance between the measurement points on the gauge increases. On the other hand, as the gauge length decreases, the SN ratio (signal-to-noise ratio) decreases because the phase difference between the non-vibrating state and the vibrating state decreases, and the signal source candidate position estimation accuracy (spatial resolution) increases because the distance between the measurement points on the gauge decreases.

As described above, in the length of gauge length, there is a trade-off relationship between the SN ratio and the signal source candidate position estimation accuracy. Therefore, if the gauge length is shortened to increase the signal source candidate position estimation accuracy, the SN ratio decreases, and the detection performance decreases. On the other hand, when an attempt is made to increase the detection performance by increasing the gauge length and increasing the SN ratio, the signal source candidate position estimation accuracy decreases. That is, it is necessary to measure the phase difference signal by setting the gauge length to an optimum value. The length of gauge length needs to be within a predetermined length.

### <Operation of Signal Processing Apparatus>

An operation of the signal processing apparatus according to the first example embodiment will be described.

In this example, a sound source will be described as an example of the signal source.

### <Input Information>

As illustrated in FIG. 2, the input information input to the signal source candidate generation means 111 of the signal processing apparatus 11 includes signal source candidate positions, optical fiber laying information, and (optical fiber) gauge length.

As the signal source candidate position, for example, the position xₛ of a sound source (signal source)
can be expressed as

$${x}_{s} = ( {x}_{s} , {y}_{s} , {z}_{s} ) . \qquad ( 1 )$$

In addition, expansion/contraction S of the optical fiber at the measurement point at this time can be expressed as S (x, xₛ, t). Then, for example, when an acoustic signal having a sound velocity c propagates into the air, the expansion and contraction S of the optical fiber at the measurement point
can be expressed as

$$S ( x , {x}_{s} , t ) = F [ ct - \vert {x}_{s} - x ( d ) \vert ] . \qquad ( 2 )$$

Here, F is a function of the acoustic signal.

In addition, environmental noise appearing according to the laying information of the optical fiber may be formulated and applied to the expansion/contraction S.

The optical fiber laying information is the layout of the optical fiber to be laid and the laying environment. The layout includes, for example, a coil shape and a linear shape. In addition, the laying environment includes, for example, an overhead line and ground laying. The property of the measurement result (how the optical fiber is distorted) varies depending on the optical fiber laying information. When the optical fiber is laid in a coil shape, the measurement point is regarded as a point. In addition, when the optical fiber is linearly laid, the measurement point is regarded as a line. The coil shape is, for example, a state of an overhead line bonded to a utility pole. In addition, a large environmental noise may be applied to the background according to the laying situation of the optical fiber. For example, in the case of an overhead line, background noise due to wind may be applied.

As described above, in the optical fiber laying information, for example, the distribution or shape of the optical fiber, such as a linear shape and a coil shape, is set. Here, for example, when using a sensor such as a DAS apparatus, the position of the measurement point of the optical fiber is a function of the length d, and the coordinate x (d)
can be expressed as

$$x ( d ) = ( x ( d ) , y ( d ) , z ( d ) ) . \qquad ( 3 )$$

Here, the length d is the length of the optical fiber from the sensor to the measurement point.

The gauge length G is as illustrated in FIG. 3. The signal source candidate condition selection means 114 selects predetermined composite data having the highest similarity from a plurality of pieces of composite data in which the same value as the value of the gauge length set when acquiring the measured data is set, and estimates the signal source candidate position corresponding to the predetermined composite data as a sound source.

An operation of each element of the signal processing apparatus 11 will be described.

### <Signal Source Candidate Generation Means>

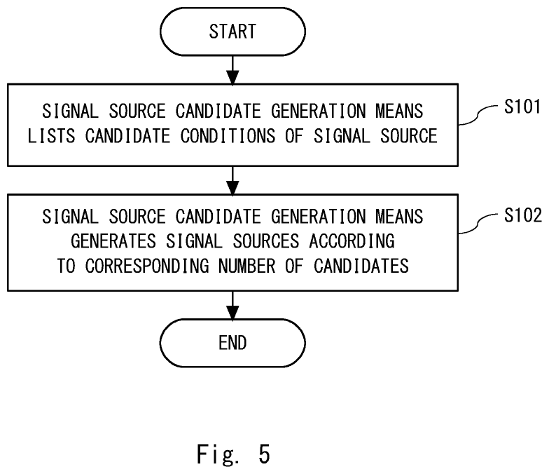

FIG. 5 is a flowchart illustrating an operation of the signal source candidate generation means according to the first example embodiment.

As illustrated in FIG. 5, the signal source candidate generation means 111 lists candidate conditions of the signal source (step S101). For example, when the candidate positions of the coordinates xₛ=(xₛ, yₛ, zₛ) of the position of the sound source are listed, the signal source candidate generation means 111 lists positions in a plurality of meshes obtained by dividing a predetermined space of interest into a mesh shape, as the candidate positions of the signal source, by the number of patterns divided by the meshes. In addition, for example, when listing the candidates of a moving signal source (for example, a signal emitted from a vehicle traveling along an optical fiber), the signal source candidate generation means 111 lists candidates of a moving speed. In this case, a plurality of positions along the optical fiber may be listed as a plurality of signal source candidate positions.

The signal source candidate generation means 111 generates signal sources corresponding to the corresponding number of candidates in all patterns (step S102).

### <Composite Data Generation Means>

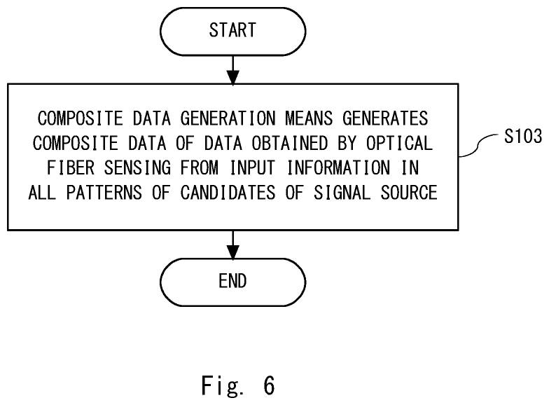

FIG. 6 is a flowchart illustrating an operation of the composite data generation means according to the first example embodiment.

As illustrated in FIG. 6, the composite data generation means 112 generates composite data (distortion signal) of data obtained by optical fiber sensing from the input information in all patterns of the candidates of the signal source (step S103). The input information includes optical fiber laying information, a gauge length, and a signal source candidate position. The composite data generation means 112 generates a distortion signal obtained by combining phase difference signals obtained by optical fiber sensing in all patterns in which each piece of input information varies within a predetermined range. In addition, in the optical fiber sensing, vibration generated in any section on the optical fiber can be detected as a phase difference signal.

That is, the composite data generation means 112 generates composite data using the optical fiber laying information, the gauge length G, and the signal source candidate position.

Specifically, first, the composite data generation means 112 calculates, as composite data, distortion (distortion signal) εₛᵢₘ(d, t) of the optical fiber due to the acoustic signal in the gauge length section of the optical fiber generated by the acoustic signal. The distortion signal εₛᵢₘ(d, t) as composite data is expressed by Equation (4).

$${ε}_{sim} ( d , t ) = {\int }_{d - G}^{d} S [ x ( s ) , {x}_{s} , t ] ds / G \qquad ( 4 )$$

Here, d is the length of the optical fiber from the sensor to the measurement point, t is the time, and G is the gauge length. In addition, S (x, xₛ, t) is expansion and contraction of the optical fiber, and xₛ is the position of the sound source. x(s) is a coordinate x(s)=(x(s), y(s), z(s)), and s is an integral variable.

The composite data generation means 112 generates the distortion signal εₛᵢₘ(d, t) which is composite data corresponding to the number of signal source candidates generated by the signal source candidate generation means 111.

### <Composite Data Storage Means>

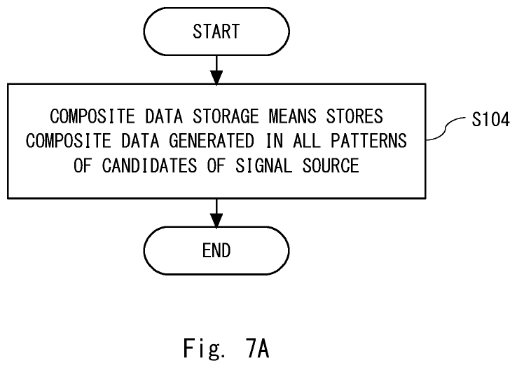

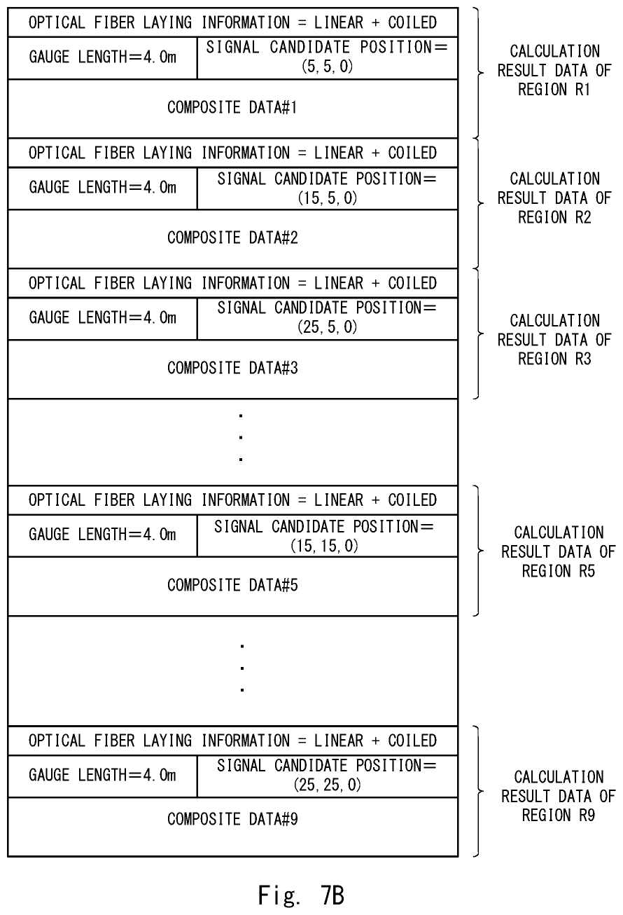

FIG. 7A is a flowchart illustrating an operation of the composite data storage means according to the first example embodiment.

FIG. 7B is a schematic diagram illustrating a storage table of the composite data storage means according to the first example embodiment.

As illustrated in FIG. 7A, the composite data storage means 115 stores composite data (distortion signal) generated in all patterns of the candidate positions of the signal source together with the optical fiber laying information, the gauge length, and the signal source candidate position that are conditions at the time of calculation (step S104). For example, when the candidate conditions (candidate positions) of the coordinates xₛ=(xₛ, yₛ, zₛ) of the sound source are listed, the signal source candidate generation means 111 assigns the coordinates xₛ of the sound source as conditions to the composite data that has generated the coordinates of the candidate positions and stores the obtained composite data.

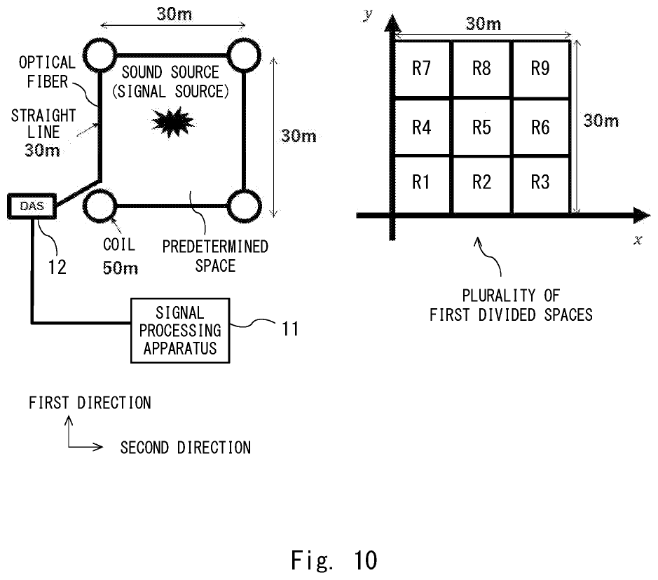

More specifically, as illustrated in FIG. 7B, the composite data storage means 115 stores, in a table, calculation results of regions R1 to R9 of a first divided space obtained by dividing a predetermined space illustrated in FIG. 10 described later into a mesh shape. The composite data storage means 115 stores composite data #1 together with information of optical fiber laying information=linear+coiled, gauge length=4 m, and signal source candidate position=(5, 5, 0) when the composite data #1 is calculated. The composite data storage means 115 stores composite data #2 together with information of optical fiber laying information=linear+coiled, gauge length=4 m, and signal source candidate position=(15, 5, 0) when the composite data #2 is calculated. The composite data storage means 115 similarly stores calculation results of regions R3 to R9 in the table.

In addition, the optical fiber laying information=linear+coiled indicates that the optical fiber is laid in a linear shape and a circular shape (referred to as a coil shape) as illustrated in the left diagram of FIG. 10. In addition, the signal source candidate positions indicate the positions of the centers of the regions R1 to R9 of the first divided space obtained by dividing the predetermined space illustrated in the right diagram of FIG. 10 into a mesh shape.

### <Measured Data Processing Means>

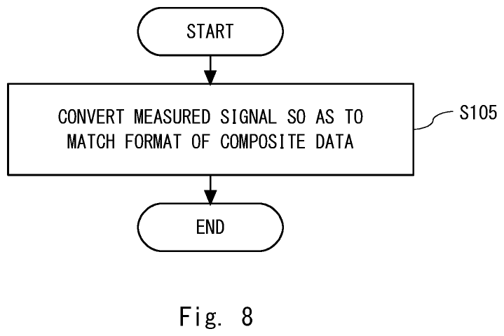

FIG. 8 is a flowchart illustrating an operation of the measured data processing means according to the first example embodiment.

As illustrated in FIG. 8, the measured data processing means 113 converts the measured phase difference signal so as to match the format of the distortion signal that is composite data (step S105). For example, when the distortion (distortion signal) of the optical fiber is calculated by the composite data generation means 112, the phase difference signal Δφ of the backscattered light obtained by the DAS apparatus is converted into a dynamic distortion signal ε(d, t) of the optical fiber. At this time, the distortion signal ε(d, t) is expressed by Equations (5) and (6).

In addition, the phase difference signal Δφ is measured by, for example, a DAS apparatus, and is obtained by measuring the phase difference signal of backscattered light in the optical fiber gauge length section when the optical pulse signal is input to the optical fiber.

$$ε ( d , t ) = \frac{λ}{4 π nG ξ} Δφ ( d , t ) \qquad ( 5 )$$

$$Δφ ( d , t ) = [ φ ( d , t ) - φ ( d - G , t ) ] - {φ}_{0} \qquad ( 6 )$$

Here,
φ₀ is a reference phase.
λ is an optical wavelength of the optical pulse signal, and is 1.55 μm.
n is a refractive index of the optical fiber.
G is a gauge length.
ξ is the photoelastic magnification, and 0.78 is set.

In addition, when the format of the composite data is a phase difference signal, conversion as in Equation (5) does not need to be performed.

### <Signal Source Candidate Condition Selection Means>

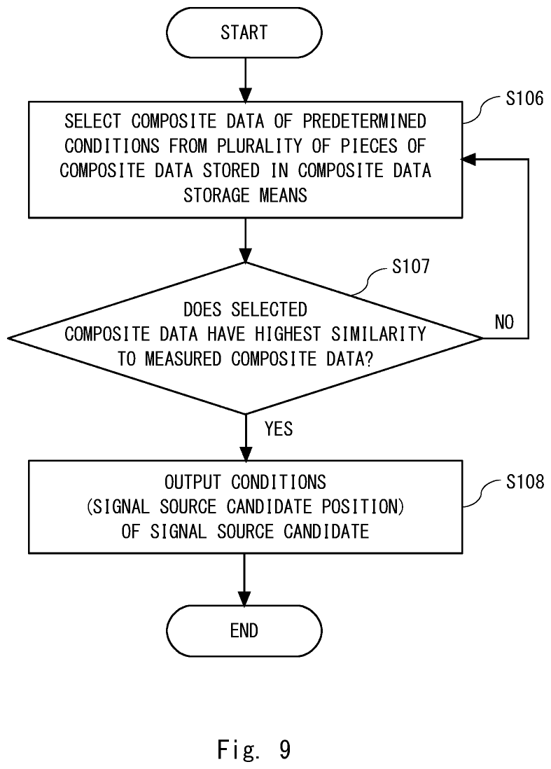

FIG. 9 is a flowchart illustrating an operation of the signal source candidate condition selection means according to the first example embodiment.

As illustrated in FIG. 9, the signal source candidate condition selection means 114 selects composite data of predetermined conditions from a plurality of pieces of composite data calculated in advance and stored in the composite data storage means 115 based on the conditions of the signal source (speed of signal source, coordinate position of signal source (signal source candidate position), waveform, and the like) (step S106).

The signal source candidate condition selection means 114 determines whether or not the selected composite data of the predetermined conditions has the highest similarity to the measured composite data (step S107).

When the selected composite data has the highest similarity to the measured data (step S107: Yes), the signal source candidate condition selection means 114 selects the selected composite data as predetermined composite data, and outputs conditions (signal source candidate position) of a signal source candidate corresponding to the predetermined composite data (step S108).

When the selected composite data does not have the highest similarity to the measured data (step S107: No), the signal source candidate condition selection means 114 returns to step S106.

The composite data is, for example, the above-described distortion signal, and the conditions are, for example, the coordinate position (signal source candidate position) of the signal source. Therefore, the operations of steps S106 to S108 are summarized as follows.

The signal source candidate condition selection means 114 selects a predetermined distortion signal having the highest similarity to the distortion signal obtained by measurement from a plurality of distortion signals calculated in advance, and estimates a signal source candidate position corresponding to the predetermined distortion signal as a signal generation position. Here, the distortion signal obtained by measurement is obtained by converting a phase difference signal obtained by measurement into a distortion signal.

Here, selecting the predetermined composite data having the highest similarity means selecting composite data having the maximum similarity between composite data (distortion signal) εₛᵢₘ obtained by calculation in which a plurality of signal source candidate positions are prepared in advance and measured composite data (distortion signal) ε.

Specifically, a two-dimensional cross-correlation function between a plurality of pieces of data εₛᵢₘ(d, t) and ε(d, t) is obtained, and εₛᵢₘ(d, t) having the maximum similarity is obtained.

In addition, the amplitudes of εₛᵢₘ(d, t) and & (d, t) may be imaged, and template matching (for example, sum of squared difference (SSD) or normalized cross correlation (NCC)) between the images may be used to calculate εₛᵢₘ(d, t) having the maximum similarity.

The signal source candidate condition selection means 114 calculates the maximum similarity in this manner, and estimates the position of the coordinate when the similarity takes a maximum value as the generation position of the signal source.

### Specific Example of First Example Embodiment

Position estimation of a sound source (signal source) in a region surrounded by a linear optical fiber and a coiled optical fiber will be described as an example.

FIG. 10 is a schematic diagram illustrating a specific example of the system according to the first example embodiment.

As illustrated in FIG. 10, when sound source position estimation in the two-dimensional space is performed in a region (predetermined space) surrounded by the linear optical fiber and the coiled optical fiber, it is estimated where in the regions R1 to R9 the sound (assuming an explosion) is generated from. Such a specific example is applied to a case where the position of an abnormal sound or a dangerous explosion sound is detected. In addition, a first divided space obtained by dividing a predetermined space into a mesh shape is defined as a region R1 to a region R9.

It is considered that the signal source candidate position exists in any one of the regions R1 to R9 obtained by dividing a space (region) surrounded by the optical fiber into a mesh shape. In addition, in order to improve the spatial resolution of the estimation result, the number of divisions to be divided into the mesh shape may be further increased.

In this example, the optical fiber laying information is to proceed in a straight line in a first direction from a start point, at which the distributed acoustic sensing (DAS) apparatus 12 is disposed, by a first length, draw a circle with a circumference of a second length, proceed in a second direction perpendicular to the first direction by the first length, draw a circle with a circumference of the second length, proceed in a direction opposite to the first direction by the first length, draw a circle with a circumference of the second length, proceed in a direction opposite to the second direction by the first length, and draw a circle with a circumference of the second length. In addition, the first length is 30 m (meters), and the second length is 50 m.

The optical fiber laying information can also be expressed as the distribution x(d) of the optical fiber as well as the expression described above.

$$x ( d ) = ( x ( d ) , y ( d ) ) \qquad ( 7 )$$

Here, d is the length of the optical fiber from the distributed acoustic sensing apparatus 12 to the measurement point. When the optical fiber laying information is expressed by Equation (7), the coil portion is regarded as a point and the straight portion is regarded as a wire. In order to give a realistic distribution, the coil portion may be a circle having a radius r.

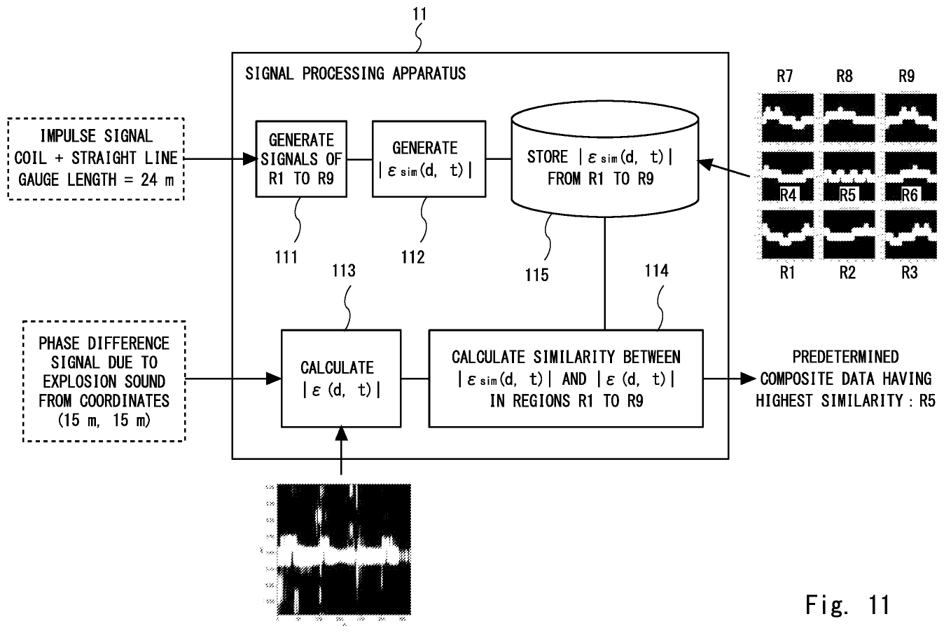

FIG. 11 is a block diagram illustrating processing contents in each element of the signal processing apparatus according to the first example embodiment.

As illustrated in FIG. 11, for example, a model called an impulse signal S is used as an explosion sound.

$$S ( x , {x}_{s} , t ) = A δ [ ct - \vert {x}_{s} - x ( d ) \vert ] \qquad ( 8 )$$

Here, A is a constant and δ is a δ function.

In order to obtain a more realistic signal, a waveform acquired in advance may be used instead of the impulse signal S.

In addition, when it is known that a stationary environmental noise exists in a part of the optical fiber, the information may be applied to Equation (8) as noise.

In the calculation of the similarity between |εₛᵢₘ(d, t)| and |ε(d, t)| in the regions R1 to R9 by the signal source candidate condition selection means 114, for example, a two-dimensional cross-correlation function is used. In order to improve performance, (optional) template matching may be used.

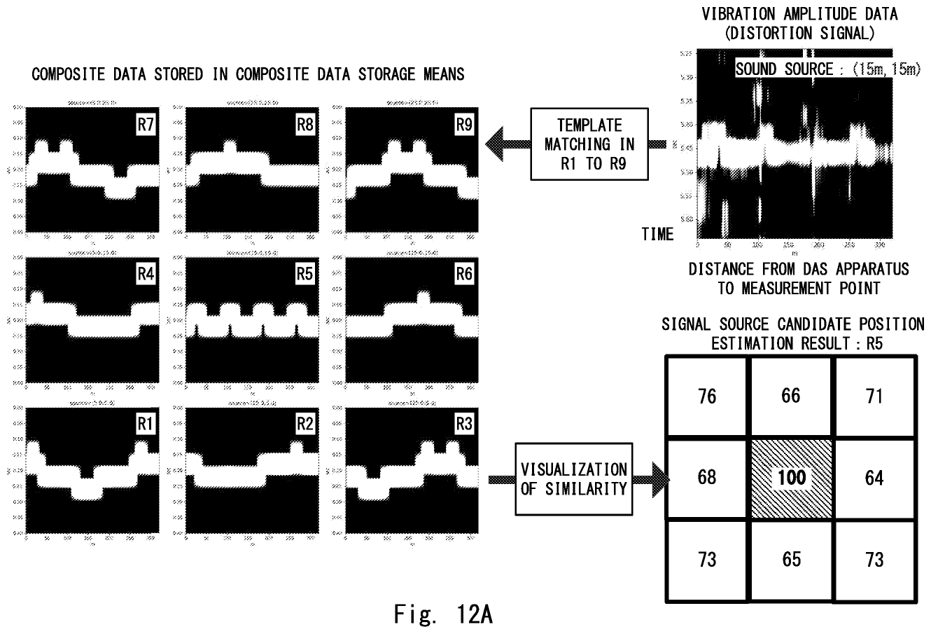

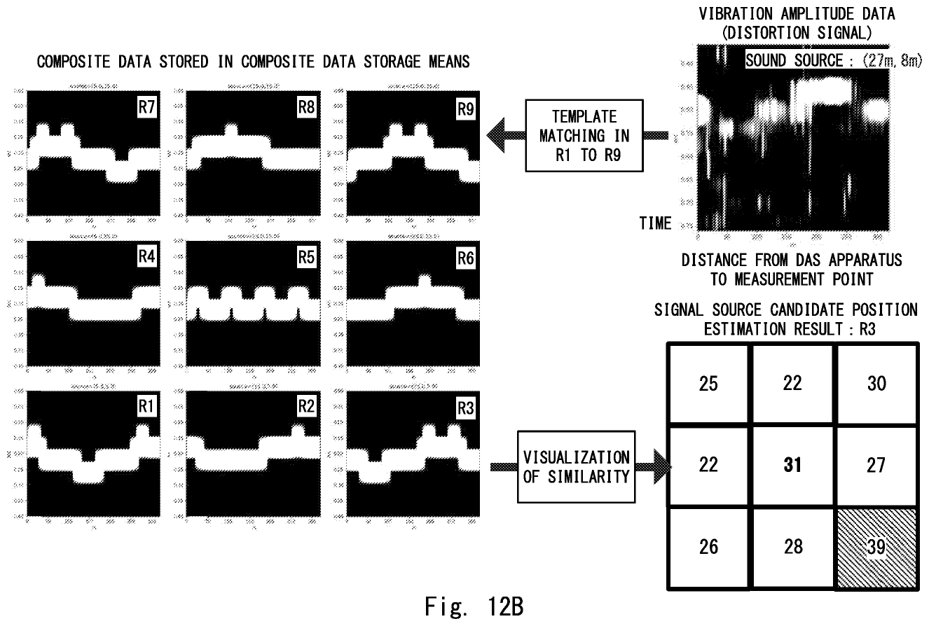

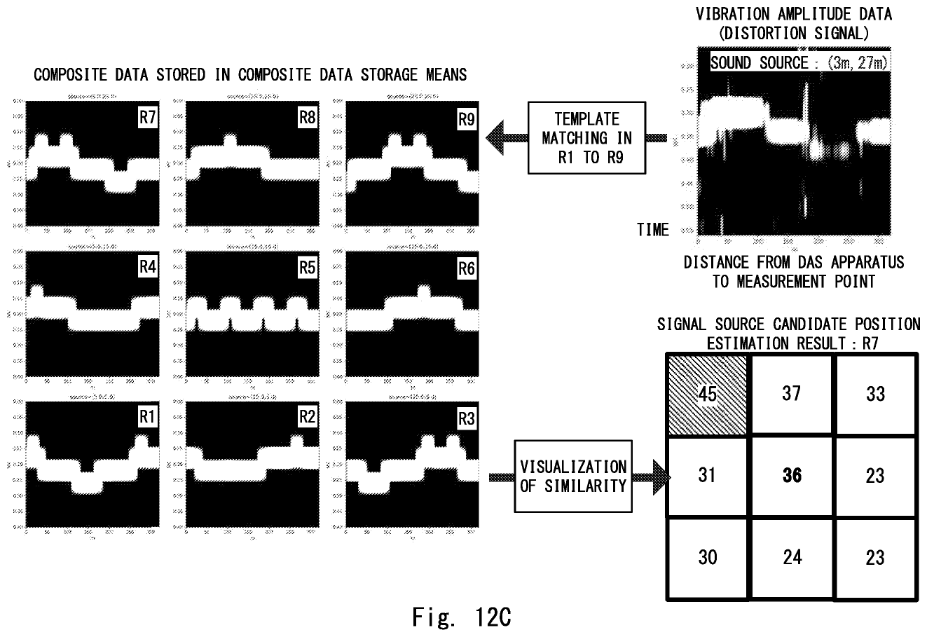

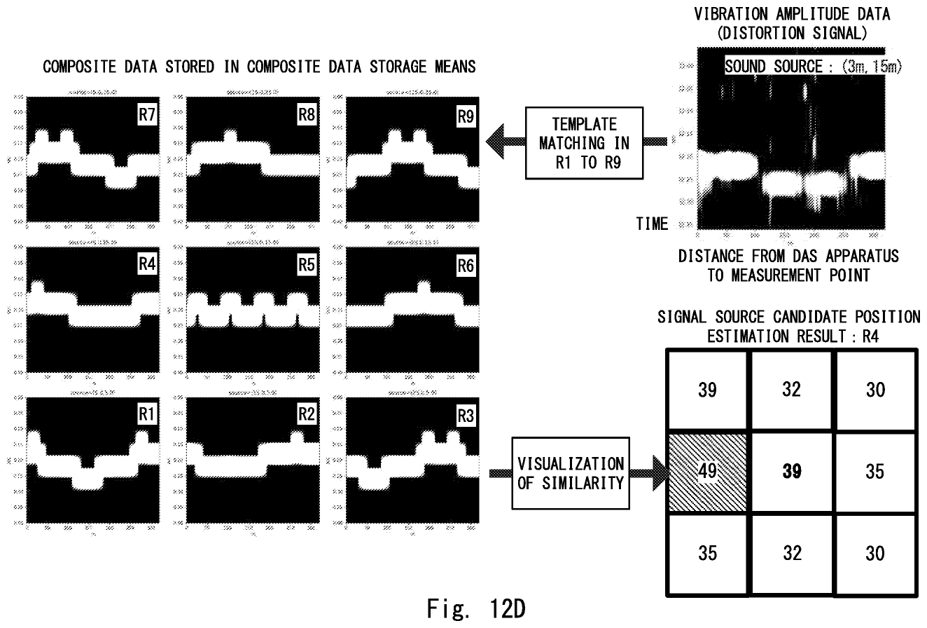

FIG. 12A is a schematic diagram illustrating similarity in the signal source candidate condition selection means according to the first example embodiment.

FIG. 12A illustrates an example of a case where a sound (assuming an explosion sound) is generated in the region R5.

As shown in FIG. 12A, the signal source candidate condition selection means 114 compares “one of a plurality of pieces of composite data” stored in the composite data storage means 115 with “vibration amplitude data” obtained by converting the phase difference signal measured by the DAS apparatus into a distortion signal by the measured data processing means 113. The signal source candidate condition selection means 114 compares the composite data of each of the regions R1 to R9 with the vibration amplitude data using template matching. The signal source candidate condition selection means 114 may visualize the similarity obtained as a result of the comparison.

Specifically, the signal source candidate condition selection means 114 compares the composite data of the region R1 with the vibration amplitude data using template matching. As a result, the signal source candidate condition selection means 114 acquires “73” as the similarity. Then, the signal source candidate condition selection means 114 compares the composite data of the region R2 with the amplitude data. As a result, the signal source candidate condition selection means 114 acquires “65” as the similarity. Thereafter, the signal source candidate condition selection means 114 compares the composite data of each of the regions R3 to R9 with the vibration amplitude data to acquire the similarity.

Thereafter, the signal source candidate condition selection means 114 selects composite data having the highest similarity among the acquired similarities. In this example, the composite data having the highest similarity is the composite data of the region R5. Therefore, the signal source candidate condition selection means 114 estimates the region R5 as the position of the sound source as a signal source candidate position estimation result.

FIG. 12B is a schematic diagram illustrating similarity in the signal source candidate condition selection means according to the first example embodiment.

FIG. 12B illustrates an example of a case where a sound (assuming an explosion sound) is generated in the region R3.

As illustrated in FIG. 12B, the signal source candidate condition selection means 114 compares the composite data and the amplitude data of each of the regions R1 to R9 using template matching, and obtains the similarity between the regions R1 to R9. The signal source candidate condition selection means 114 selects composite data having the highest similarity, that is, composite data having the similarity of “39” among the acquired similarities. Since the region corresponding to the composite data having the similarity “39” is the region R3, the signal source candidate condition selection means 114 estimates the region R3 as the position of the sound source as a signal source candidate position estimation result.

FIG. 12C is a schematic diagram illustrating similarity in the signal source candidate condition selection means according to the first example embodiment.

FIG. 12C illustrates an example of a case where a sound (assuming an explosion sound) is generated in the region R7.

As illustrated in FIG. 12C, the signal source candidate condition selection means 114 compares the composite data and the amplitude data of each of the regions R1 to R9 using template matching, and obtains the similarity between the regions R1 to R9. The signal source candidate condition selection means 114 selects composite data having the highest similarity, that is, composite data having the similarity of “45” among the acquired similarities. Since the region corresponding to the composite data having the similarity “45” is the region R7, the signal source candidate condition selection means 114 estimates the region R7 as the position of the sound source as a signal source candidate position estimation result.

FIG. 12D is a schematic diagram illustrating similarity in the signal source candidate condition selection means according to the first example embodiment.

FIG. 12D illustrates an example of a case where a sound (assuming an explosion sound) is generated in the region R4.

As illustrated in FIG. 12D, the signal source candidate condition selection means 114 compares the composite data and the amplitude data of each of the regions R1 to R9 using template matching, and obtains the similarity between the regions R1 to R9. The signal source candidate condition selection means 114 selects composite data having the highest similarity, that is, composite data having the similarity of “49” among the acquired similarities. Since the region corresponding to the composite data having the similarity “49” is the region R4, the signal source candidate condition selection means 114 estimates the region R4 as the position of the sound source as a signal source candidate position estimation result.

### <Features>

Here, features of the first example embodiment will be described below.

In order to detect the characteristics of signals around the optical fiber, a simulation in which a plurality of signal source candidates are prepared in advance is performed using a theoretical model in which the optical fiber laying state, the waveform of the vibration source, and the gauge length are used as inputs.

A condition (position) of a vibration source having the highest similarity between composite data obtained by simulation of optical fiber sensing data and measured data is selected.

The condition (position) of the selected result is set as the generation position of the signal source.

### Second Example Embodiment

### <Configuration>

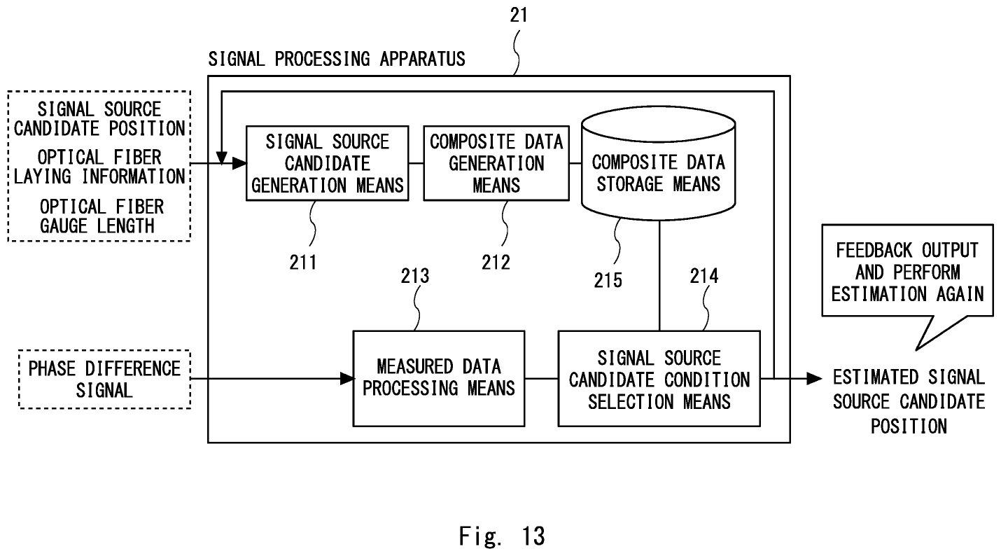

FIG. 13 is a block diagram illustrating a signal processing apparatus according to a second example embodiment.

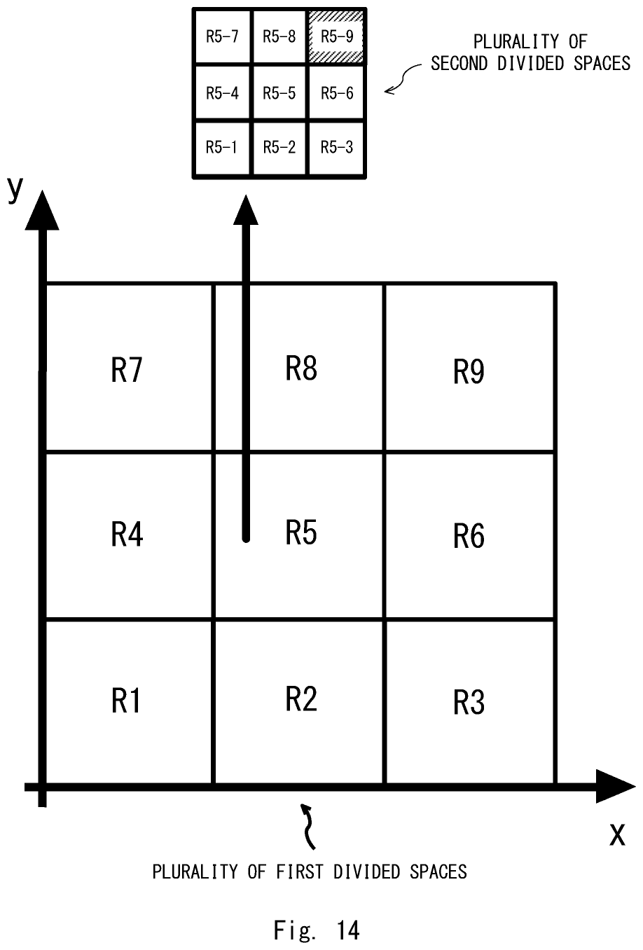

FIG. 14 is a schematic diagram illustrating a divided space according to the second example embodiment.

As illustrated in FIGS. 13 and 14, a signal processing apparatus 21 according to the second example embodiment is different from the signal processing apparatus 11 according to the first example embodiment in that a predetermined signal source candidate position is selected from a plurality of second divided spaces obtained by further dividing the first divided space into a mesh shape and the predetermined signal source candidate position is estimated as a signal generation position.

As illustrated in FIG. 13, as a first stage, the signal source candidate condition selection means 214 estimates a predetermined signal source candidate position (sound source position) from spaces (first divided spaces) divided into 3×3 meshes. Thereafter, as a second stage, the signal source candidate condition selection means 214 feeds back the predetermined signal source candidate position to the signal source candidate generation means 211, and estimates the signal generation position again from spaces (second divided spaces) obtained by further subdividing the space including the estimated predetermined signal source candidate position into meshes.

### <Operation>

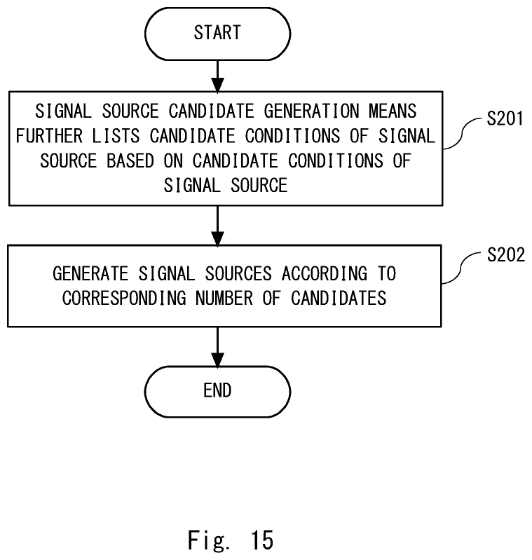

FIG. 15 is a flowchart illustrating an operation of the signal processing apparatus according to the second example embodiment.

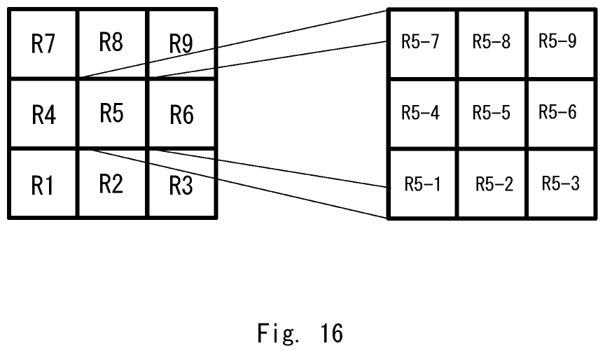

FIG. 16 is a schematic diagram illustrating a divided space according to the second example embodiment.

As illustrated in FIG. 15, the signal source candidate generation means 211 further lists the candidate conditions of the signal source using the signal source information based on the candidate conditions of the signal source (step S201).

For example, candidate conditions of the coordinates xₛ=(xₛ, yₛ, zₛ) of the sound source are listed based on the coordinates of the signal source candidate position. That is, as illustrated in FIG. 16, when the region R5 is input as a signal source candidate position among the regions R1 to R9 in the specific example of the first example embodiment, the predetermined space (region) R5 is divided into a mesh shape, and regions R5-1 to R5-9 which are the candidate conditions of the signal source are listed.

The composite data generation means 212 generates all patterns of signal sources corresponding to the number of corresponding candidate conditions (step S202).

Specifically, the following operation is performed.

(Step 1) The region R5 (first divided space) including the estimated predetermined signal source candidate position is fed back to the signal source candidate generation means 211.

(Step 2) The signal source candidate generation means 211 generates new signal source candidate positions (regions R5-1 to R5-9 are defined and referred to as a plurality of second divided spaces) by further subdividing the region R5 into a mesh shape.

(Step 3) Calculation (simulation) is performed on the regions R5-1 to R5-9 to generate and store composite data.

(Step 4) The signal source candidate condition selection means 214 selects a predetermined signal source candidate position from the plurality of second divided spaces, and estimates and outputs the predetermined signal source candidate position as a signal generation position.

(Step 5) (Step 1) to (Step 4) are repeated until predetermined accuracy is achieved.

The signal processing apparatus 21 according to the second example embodiment estimates an approximate region of the signal generation position in the first stage, and estimates the signal generation position in more detail from the region estimated in the second stage. As a result, the signal processing apparatus 21 according to the second example embodiment can more accurately estimate a signal generation position (a position of a signal source) than signal processing apparatus 11 according to the first example embodiment.

In addition, as in the signal processing apparatus 21 according to the second example embodiment, there is also a method of subdividing the entire predetermined space into a mesh shape in the first stage as a method of accurately estimating the signal generation position. In this method, since it is necessary to store the subdivided composite data, the storage capacity needs to be increased. On the other hand, since the composite data generation means 212 according to the second example embodiment divides only the region (space) including the predetermined signal source candidate position estimated in the first stage in the second stage, the storage capacity can be reduced as compared with the method of dividing the entire predetermined space.

### <Features>

In the example embodiment, it is possible to perform analysis in consideration of the laying status of the optical fiber or dependency on the setting of the gauge length, which are properties unique to optical fiber sensing.

Since the example embodiment does not require the collection of measured data in advance, it is possible to estimate the generation position of a signal source with high accuracy for unknown data.

The example embodiment can be used in combination with a technique based on sound arrival time detection for estimating the position of the signal source. Therefore, it is possible to further improve the estimation accuracy. For example, according to the example embodiment, the estimation range can be determined by template matching with the composite data, and then a detailed position estimation can be performed using only measurement points with a high signal-to-noise ratio narrowed down within the estimation range.

The example embodiment can be applied to a system for detecting the position of an abnormal acoustic signal source or a system for estimating the speed of a signal source from a moving body moving along the optical fiber.

In the above example embodiment, the present invention has been described as a hardware configuration, but the present invention is not limited thereto. The present invention can also realize the processes of each component by causing a central processing unit (CPU) to execute a computer program.

In addition, in the above-described example embodiment, the program can be stored using various types of non-transitory computer-readable media and supplied to the computer. The non-transitory computer-readable media include various types of tangible storage media. Examples of the non-transitory computer-readable media include a magnetic recording medium (specifically, a flexible disk, a magnetic tape, or a hard disk drive), a magneto-optical recording medium (specifically, a magneto-optical disk), a CD-read only memory (ROM), a CD-R, a CD-R/W, and a semiconductor memory (specifically, a mask ROM, a programmable ROM (PROM), an erasable PROM (EPROM)), a flash ROM, or a random access memory (RAM). In addition, the program may be supplied to the computer by various types of transitory computer-readable media. Examples of transitory computer-readable media include electrical signals, optical signals, and electromagnetic waves. The transitory computer-readable media can supply programs to computers through a wired communication path such as electric wires and optical fibers, or wireless communication paths.

Although the invention of the present application has been described above with reference to the example embodiments, the invention of the present application is not limited to the above. Various modifications that can be understood by those skilled in the art can be made to the configuration and details of the invention of the present application within the scope of the invention.

In addition, the present invention is not limited to the example embodiments described above and can be appropriately changed without departing from the gist of the present invention.

Some or all of the above-described example embodiments may be described as in the following Supplementary Notes, but are not limited to the following Supplementary Notes.

### (Supplementary Note 1)

A signal processing apparatus including:
a signal source candidate generation means for generating a plurality of signal source candidate positions;
a composite data generation means for calculating a distortion signal, which is generated when a signal generated from a signal source distorts an optical fiber, based on a plurality of pieces of optical fiber laying information, a plurality of optical fiber gauge lengths, and a plurality of the signal source candidate positions;
a measured data processing means for receiving a phase difference signal of backscattered light in an optical fiber gauge length section when an optical pulse signal is input to the optical fiber and converting the phase difference signal into a distortion signal; and
a signal source candidate condition selection means for selecting a predetermined distortion signal having a highest similarity to the converted distortion signal from the plurality of calculated distortion signals, selecting a predetermined signal source candidate position corresponding to the predetermined distortion signal from the plurality of signal source candidate positions, and estimating the predetermined signal source candidate position as a generation position of the signal.

### (Supplementary Note 2)

The signal processing apparatus according to Supplementary Note 1, wherein
the signal source candidate generation means generates, as a plurality of the signal source candidate positions, positions in a plurality of first divided spaces obtained by dividing a predetermined space including the optical fiber into a mesh shape or a plurality of positions along the optical fiber, and
the signal source candidate condition selection means selects the predetermined signal source candidate position from the plurality of first divided spaces and estimates the predetermined signal source candidate position as the generation position of the signal.

### (Supplementary Note 3)

The signal processing apparatus according to Supplementary Note 2, wherein
the signal source candidate generation means generates a plurality of second divided spaces by further dividing the first divided space including the predetermined signal source candidate position into a mesh shape, and
the signal source candidate condition selection means selects the predetermined signal source candidate position from the plurality of second divided spaces and estimates the predetermined signal source candidate position as the generation position of the signal.

### (Supplementary Note 4)

The signal processing apparatus according to any one of Supplementary Notes 1 to 3, wherein the optical fiber laying information is to proceed in a straight line in a first direction from a start point by a first length, draw a circle with a circumference of a second length, proceed in a second direction perpendicular to the first direction by the first length, draw a circle with a circumference of the second length, proceed in a direction opposite to the first direction by the first length, draw a circle with a circumference of the second length, proceed in a direction opposite to the second direction by the first length, and draw a circle with a circumference of the second length.

### (Supplementary Note 5)

The signal processing apparatus according to any one of Supplementary Notes 1 to 4, wherein each of the plurality of optical fiber gauge lengths is within a predetermined length.

### (Supplementary Note 6)

The signal processing apparatus according to any one of Supplementary Notes 1 to 5, further including: a composite data storage means for storing the plurality of calculated distortion signals.

### (Supplementary Note 7)

The signal processing apparatus according to Supplementary Note 6, wherein the composite data storage means stores the optical fiber laying information, the optical fiber gauge lengths, the signal source candidate positions, and the distortion signals obtained as a result of the calculation in association with each other.

### (Supplementary Note 8)

The signal processing apparatus according to any one of Supplementary Notes 1 to 7, wherein the signal source candidate generation means generates a plurality of the signal source candidate positions based on the optical fiber laying information.

### (Supplementary Note 9)

The signal processing apparatus according to any one of Supplementary Notes 1 to 8, wherein the signal source candidate condition selection means narrows down a selection range for selecting the predetermined distortion signal from the plurality of calculated distortion signals based on the optical fiber laying information and the optical fiber gauge length of the optical fiber to which the optical pulse signal is input.

### (Supplementary Note 10)

A system including:
a distributed acoustic sensing (DAS) apparatus; and
a signal processing apparatus, wherein
the distributed acoustic sensing apparatus includes:
a phase difference detection means for detecting a phase difference signal of backscattered light in an optical fiber gauge length section when an optical pulse signal is input to an optical fiber, and
the signal processing apparatus includes:
a signal source candidate generation means for generating a plurality of signal source candidate positions;
a composite data generation means for calculating a distortion signal, which is generated when a signal generated from a signal source distorts an optical fiber, based on a plurality of pieces of optical fiber laying information, a plurality of optical fiber gauge lengths, and a plurality of the signal source candidate positions;
a measured data processing means for receiving the phase difference signal and converting the phase difference signal into the distortion signal; and
a signal source candidate condition selection means for selecting a predetermined distortion signal having a highest similarity to the converted distortion signal from the plurality of calculated distortion signals, selecting a predetermined signal source candidate position corresponding to the predetermined distortion signal from a plurality of the signal source candidate positions, and estimating the predetermined signal source candidate position as a generation position of the signal.

### (Supplementary Note 11)

The system according to Supplementary Note 10, wherein the signal source candidate generation means generates, as a plurality of the signal source candidate positions, positions in a plurality of first divided spaces obtained by dividing a predetermined space including the optical fiber into a mesh shape or a plurality of positions along the optical fiber, and
the signal source candidate condition selection means selects the predetermined signal source candidate position from the plurality of first divided spaces and estimates the predetermined signal source candidate position as the generation position of the signal.

### (Supplementary Note 12)

A method including:
generating a plurality of signal source candidate positions;
calculating a distortion signal, which is generated when a signal generated from a signal source distorts an optical fiber, based on a plurality of pieces of optical fiber laying information, a plurality of optical fiber gauge lengths, and a plurality of the signal source candidate positions;
receiving a phase difference signal of backscattered light in an optical fiber gauge length section when an optical pulse signal is input to the optical fiber and converting the phase difference signal into a distortion signal; and
selecting a predetermined distortion signal having a highest similarity to the converted distortion signal from the plurality of calculated distortion signals, selecting a predetermined signal source candidate position corresponding to the predetermined distortion signal from a plurality of the signal source candidate positions, and estimating the predetermined signal source candidate position as a generation position of the signal.

### (Supplementary Note 13)

A non-transitory computer-readable medium storing a program causing a computer to execute:
generating a plurality of signal source candidate positions;
calculating a distortion signal, which is generated when a signal generated from a signal source distorts an optical fiber, based on a plurality of pieces of optical fiber laying information, a plurality of optical fiber gauge lengths, and a plurality of the signal source candidate positions;
receiving a phase difference signal of backscattered light in an optical fiber gauge length section when an optical pulse signal is input to the optical fiber and converting the phase difference signal into a distortion signal; and
selecting a predetermined distortion signal having a highest similarity to the converted distortion signal from the plurality of calculated distortion signals, selecting a predetermined signal source candidate position corresponding to the predetermined distortion signal from a plurality of the signal source candidate positions, and estimating the predetermined signal source candidate position as a generation position of the signal.

### REFERENCE SIGNS LIST

10 SYSTEM
11 SIGNAL PROCESSING APPARATUS
111 SIGNAL SOURCE CANDIDATE GENERATION MEANS
112 COMPOSITE DATA GENERATION MEANS
113 MEASURED DATA PROCESSING MEANS
114 SIGNAL SOURCE CANDIDATE CONDITION SELECTION MEANS
115 COMPOSITE DATA STORAGE MEANS
12 DISTRIBUTED ACOUSTIC SENSING (DAS) APPARATUS
G GAUGE LENGTH
ΔL DISTORTION OF OPTICAL FIBER
Δφ PHASE DIFFERENCE SIGNAL
R1, R5, R9 REGION

What is claimed is:

1. A signal processing apparatus comprising:
at least one memory storing instructions, and
at least one processor configured to execute the instructions to;
generate a plurality of signal source candidate positions;
calculate a distortion signal, which is generated when a signal generated from a signal source distorts an optical fiber, based on a plurality of pieces of optical fiber laying information, a plurality of optical fiber gauge lengths, and a plurality of the signal source candidate positions;
receive a phase difference signal of backscattered light in an optical fiber gauge length section when an optical pulse signal is input to the optical fiber and converting the phase difference signal into a distortion signal; and
select a predetermined distortion signal having a highest similarity to the converted distortion signal from the plurality of calculated distortion signals, select a predetermined signal source candidate position corresponding to the predetermined distortion signal from a plurality of the signal source candidate positions, and estimate the predetermined signal source candidate position as a generation position of the signal.

2. The signal processing apparatus according to claim 1, wherein the at least one processor configured to execute the instructions to;
generate, as a plurality of the signal source candidate positions, positions in a plurality of first divided spaces obtained by dividing a predetermined space including the optical fiber into a mesh shape or a plurality of positions along the optical fiber, and
select the predetermined signal source candidate position from a plurality of the first divided spaces and estimate the predetermined signal source candidate position as the generation position of the signal.

3. The signal processing apparatus according to claim 2, wherein the at least one processor configured to execute the instructions to;
generate a plurality of second divided spaces by further dividing the first divided space including the predetermined signal source candidate position into a mesh shape, and
select the predetermined signal source candidate position from a plurality of the second divided spaces and estimate the predetermined signal source candidate position as the generation position of the signal.

4. The signal processing apparatus according to claim 1, wherein the optical fiber laying information is to proceed in a straight line in a first direction from a start point by a first length, draw a circle with a circumference of a second length, proceed in a second direction perpendicular to the first direction by the first length, draw a circle with a circumference of the second length, proceed in a direction opposite to the first direction by the first length, draw a circle with a circumference of the second length, proceed in a direction opposite to the second direction by the first length, and draw a circle with a circumference of the second length.

5. The signal processing apparatus according to claim 1, wherein each of a plurality of the optical fiber gauge lengths is within a predetermined length.

6. The signal processing apparatus according to claim 1, wherein the at least one processor further configured to execute the instructions to;
store the plurality of calculated distortion signals.

7. The signal processing apparatus according to claim 6, wherein the at least one processor configured to execute the instructions to;
store the optical fiber laying information, the optical fiber gauge lengths, the signal source candidate positions, and the distortion signals obtained as a result of the calculation in association with each other.

8. The signal processing apparatus according to claim 1, wherein the at least one processor configured to execute the instructions to;
generate a plurality of the signal source candidate positions based on the optical fiber laying information.

9. The signal processing apparatus according to claim 1, wherein the at least one processor configured to execute the instructions to;
narrow down a selection range for selecting the predetermined distortion signal from the plurality of calculated distortion signals based on the optical fiber laying information and the optical fiber gauge length of the optical fiber to which the optical pulse signal is input.

10-11. (canceled)

12. A method comprising:
generating a plurality of signal source candidate positions;
calculating a distortion signal, which is generated when a signal generated from a signal source distorts an optical fiber, based on a plurality of pieces of optical fiber laying information, a plurality of optical fiber gauge lengths, and a plurality of the signal source candidate positions;
receiving a phase difference signal of backscattered light in an optical fiber gauge length section when an optical pulse signal is input to the optical fiber and converting the phase difference signal into a distortion signal; and
selecting a predetermined distortion signal having a highest similarity to the converted distortion signal from the plurality of calculated distortion signals, selecting a predetermined signal source candidate position corresponding to the predetermined distortion signal from a plurality of the signal source candidate positions, and estimating the predetermined signal source candidate position as a generation position of the signal.

13. A non-transitory computer-readable medium storing a program causing a computer to execute:
generating a plurality of signal source candidate positions;
calculating a distortion signal, which is generated when a signal generated from a signal source distorts an optical fiber, based on a plurality of pieces of optical fiber laying information, a plurality of optical fiber gauge lengths, and a plurality of the signal source candidate positions;
receiving a phase difference signal of backscattered light in an optical fiber gauge length section when an optical pulse signal is input to the optical fiber and converting the phase difference signal into a distortion signal; and
selecting a predetermined distortion signal having a highest similarity to the converted distortion signal from the plurality of calculated distortion signals, selecting a predetermined signal source candidate position corresponding to the predetermined distortion signal from a plurality of the signal source candidate positions, and estimating the predetermined signal source candidate position as a generation position of the signal.
